(19) United States
(12) Patent Application Publication
(10) Pub. No.: US 2025/0335541 A1
(43) Pub. Date: Oct. 30, 2025

(54) METHOD FOR DETERMINING ATTENTION VALUE OF TRANSFORMER USING ROW CLUSTERING

(71) Applicant: Korea University Research and Business Foundation, Seoul (KR)

(72) Inventors: Han CHO, Seoul (KR); Jong Sun PARK, Seoul (KR)

(21) Appl. No.: 19/056,301

(22) Filed: Feb. 18, 2025

(30) Foreign Application Priority Data
Apr. 25, 2024 (KR) 10-2024-0055619

(51) Int. Cl. G06F 17/17; G06F 17/16

(52) U.S. Cl. CPC G06F 17/175; G06F 17/16

(57) ABSTRACT

The present disclosure is characterized by reducing the data dimension of an attention operation through row clustering on the basis of the fact that most rows constituting an attention score of a transformer have similar patterns.

### CROSS REFERENCE TO RELATED APPLICATION

The present application claims priority to Korean Patent Application No. 10-2024-0055619, filed Apr. 25, 2024, the entire contents of which is incorporated herein for all purposes by this reference.

### BACKGROUND

### Technical Field

The present disclosure relates to a method of reducing the attention operation complexity of a transformer through row clustering.

### Description of the Related Art

Recently, in the field of deep learning, transformers have shown high performance in various fields such as natural language processing, computer vision, and speech recognition. Such transformers are characterized by using correlations between input data through attention operation, which is a core feature, but resources required for attention operations are proportioned to the square of the number of input data, so there is a problem that the capacity of required memories is exponentially increased in order to process a large amount of data.

### SUMMARY

An objective of the present disclosure is to reduce resources required for operations by reducing the attention operation complexity of a transformer.

The objectives of the present disclosure are not limited to those described above and other objectives and advantages not stated herein may be understood through the following description and may be clear by embodiments of the present disclosure. Further, it would be easily known that the objectives and advantages of the present disclosure may be achieved by the configurations described in claims and combinations thereof.

In order to achieve the objectives described above, a method for determining an attention value of a transformer according to an embodiment of the present disclosure includes: applying low rank approximation to a query vector or a key vector for input of a transformer; calculating an approximate attention score by taking an inner product of the query vector and the key vector; clustering a plurality of rows constituting the approximate attention score into at least one group on the basis of similarity of the plurality of rows; determining an index of a representative row of each of the groups and creating a sub-query vector by extracting rows corresponding to indexes from the query vector; calculating a sub-attention value using the sub-query vector and the key vector; and determining an attention value by copying rows constituting the sub-attention value the groups, respectively.

The present disclosure can greatly decrease calculation complexity and the capacity of a memory required for operations by reducing the data dimension of an attention operation through row clustering on the basis of the fact that most rows constituting an attention score of a transformer have similar patterns.

Detailed effects of the present disclosure in addition to the above effects will be described with the following detailed description for accomplishing the present disclosure.

### BRIEF DESCRIPTION OF THE DRAWINGS

FIG. 1 is a flowchart showing a method for determining an attention value of a transformer according to an embodiment of the present disclosure;

FIG. 2 is a diagram showing an attention operation of an existing transformer;

FIG. 3 is a diagram showing a process of calculating an approximate attention score;

FIG. 4 is a diagram illustrating clustering of an approximate attention score;

FIG. 5 is a diagram illustrating process of determining the index of a representative row of each group;

FIG. 6 is a diagram showing a sub-query vector that is created in accordance with the index of a representative row;

FIG. 7 is a diagram showing a process of determining an attention value using a sub-query vector;

FIG. 8 is a diagram showing an attention value that is determined by copying a sub-attention value; and

FIG. 9 is a diagram comparing the performance of the present disclosure with the related art.

### DETAILED DESCRIPTION

The objects, characteristics, and advantages will be described in detail below with reference to the accompanying drawings, so those skilled in the art may easily achieve the spirit of the present disclosure. However, in describing the present disclosure, detailed descriptions of well-known technologies will be omitted so as not to obscure the description of the present disclosure with unnecessary details. Hereinafter, exemplary embodiments of the present disclosure will be described with reference to accompanying drawings. The same reference numerals are used to indicate the same or similar components in the drawings.

Although terms “first”, “second”, etc. are used to describe various components in the specification, it should be noted that these components are not limited by the terms. These terms are used to discriminate one component from another component and it is apparent that a first component may be a second component unless specifically stated otherwise.

Further, when a certain configuration is disposed “over (or under)” or “on (beneath)” a component in the specification, it may mean not only that the certain configuration is disposed on the top (or bottom) of the component, but that another configuration may be interposed between the component and the certain configuration disposed on (or beneath) the component.

Further, when a certain component is “connected”, “coupled”, or “jointed” to another component in the specification, it should be understood that the components may be directly connected or jointed to each other, but another component may be “interposed” between the components or the components may be “connected”, “coupled”, or “jointed” through another component.

Further, singular forms that are used in this specification are intended to include plural forms unless the context clearly indicates otherwise. In the specification, terms “configured”, “include”, or the like should not be construed as necessarily including several components or several steps described herein, in which some of the components or steps may not be included or additional components or steps may be further included.

Further, the term “A and/or B” stated in the specification means that A, B, or A and B unless specifically stated otherwise, and the term “C to D” means that C or more and D or less unless specifically stated otherwise.

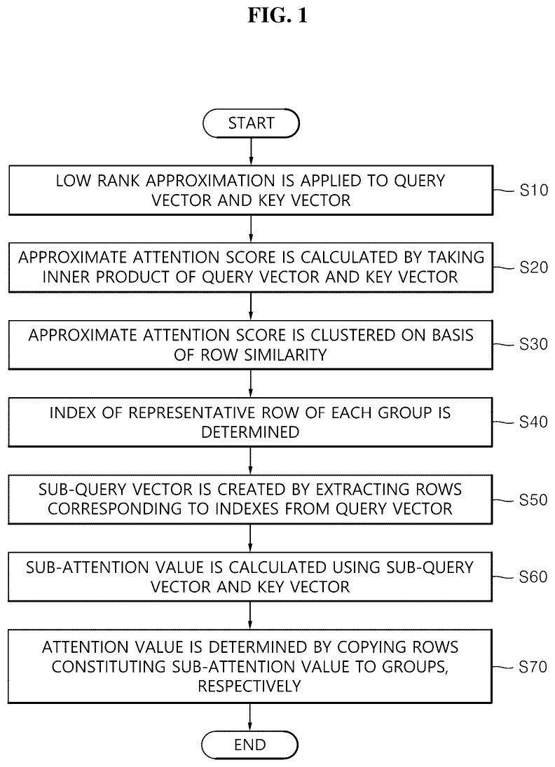

The present disclosure relates to a method of accelerating an attention operation of a transformer through row clustering. Hereafter, a method for determining an attention value of a transformer according to an embodiment of the present disclosure is described in detail with reference to FIG. 1 to FIG. 8.

FIG. 1 is a flowchart showing a method for determining an attention value of a transformer according to an embodiment of the present disclosure.

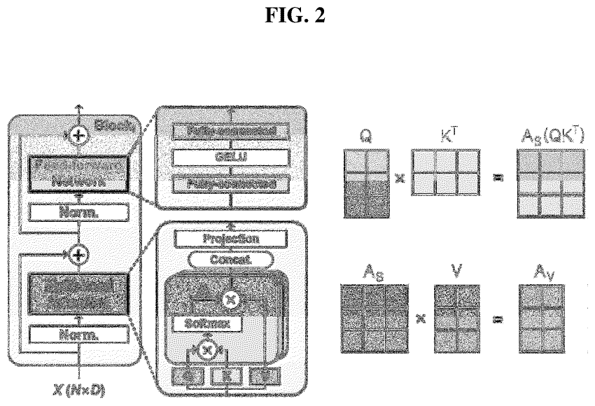

FIG. 2 is a diagram showing an attention operation of an existing transformer.

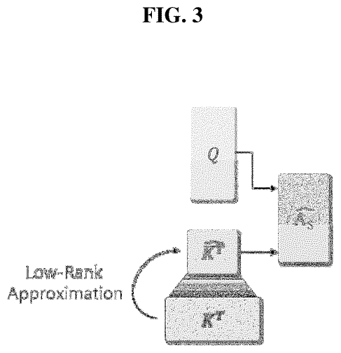

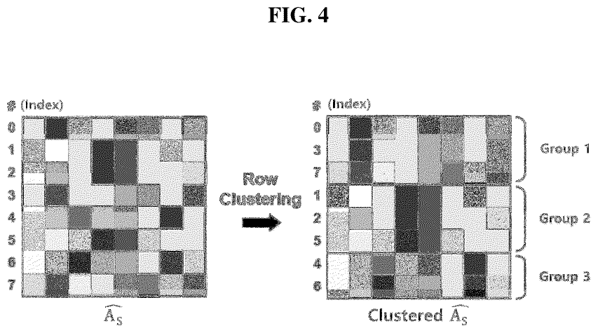

FIG. 3 is a diagram showing a process of calculating an approximate attention score and FIG. 4 is a diagram illustrating clustering of an approximate attention score.

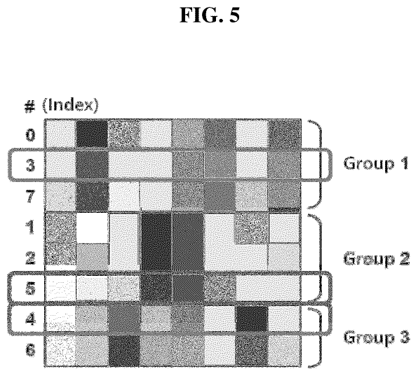

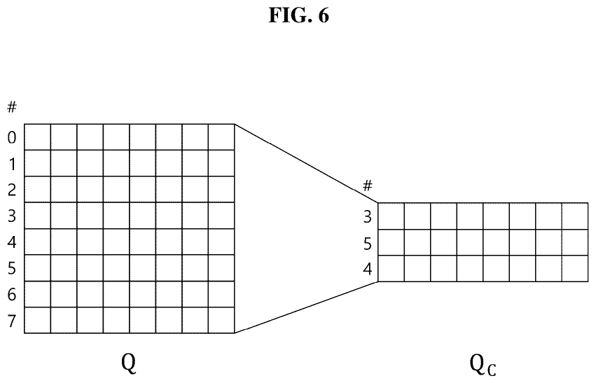

FIG. 5 is a diagram illustrating a process of determining the index of a representative row of each group and FIG. 6 is a diagram showing a sub-query vector that is created in accordance with the index of a representative row.

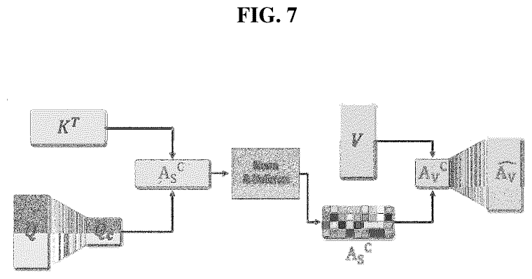

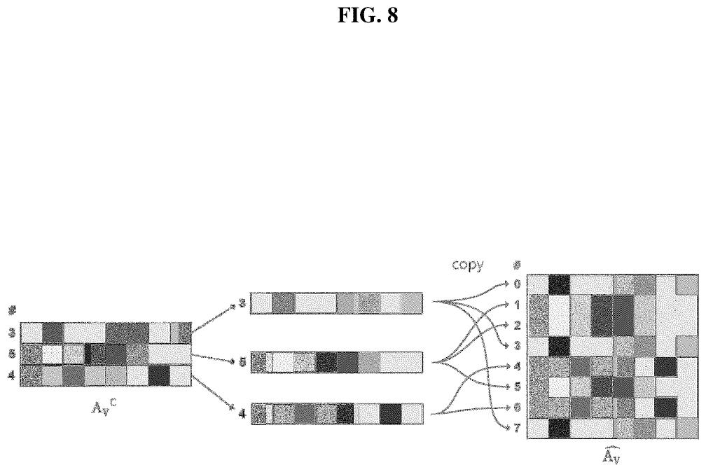

FIG. 7 is a diagram showing a process of determining an attention value using a sub-query vector and FIG. 8 is a diagram showing an attention value that is determined by copying a sub-attention value.

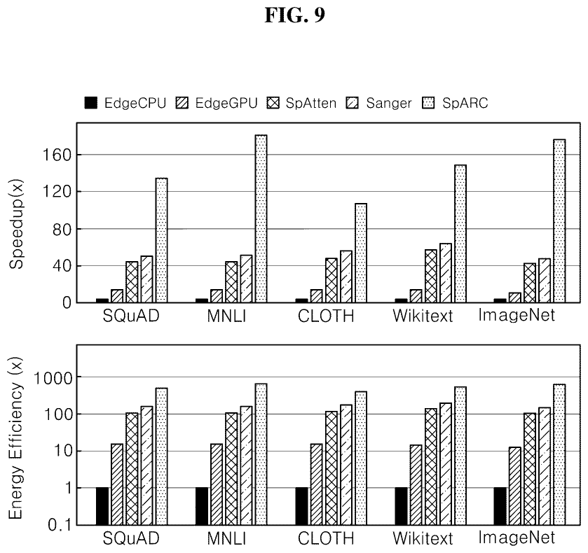

FIG. 9 is a diagram comparing the performance of the present disclosure with the related art.

Referring to FIG. 1, a method for determining an attention value of a transformer according to an embodiment of the present disclosure may include: a step of applying low rank approximation to a query vector or a key vector (S10); a step of calculating an approximate attention score by taking an inner product of the query vector and the key vector (S20); a step of clustering an approximate attention score on the basis of row similarity (S30); a step of determining the index of a representative row of each group (S40); a step of creating a sub-query vector by extracting rows corresponding to the indexes from the query vector (S50); a step of calculating a sub-attention value using the sub-query vector and the key vector (S60); and a step of determining an attention value by copying the rows constituting the sub-attention value to the groups, respectively (S70).

However, the method for determining an attention value of a transformer shown in FIG. 1 is based on an embodiment, the steps of the present disclosure are not limited to the embodiment shown in FIG. 1, and if necessary, some steps may be added, changed, or removed.

The steps shown in FIG. 1 may be performed by a processor, and to this end, the processor may include at least one physical element of application specific integrated circuits (ASICs), digital signal processors (DSPs), digital signal processing devices (DSPDs), programmable logic devices (PLDs), field programmable gate arrays (FPGAs), a controller, and a micro-controller.

Before describing the steps shown in FIG. 1 in detail, an attention operation that is performed by a transformer is described with reference to FIG. 2.

Referring to FIG. 2, a transformer can perform an attention operation (e.g., multi-head attention) as a machine learning method for sequence input. The attention operation, which is a methodology for using the correlation between sequences of input X, is, in detail, a method that enables efficient extraction of contextual information by focusing on relatively important elements and ignoring less important elements in input X.

To this end, the transformer first creates a query vector Q, a key vector K, and a value vector V for input data, calculates an attention score A_{S} by taking an inner product of the query vector Q and the key vector K, and then calculates an attention value A_{V} by multiplying the attention score A_{S} by the value vector V. However, the time complexity of this operation process is proportioned to the square N² of the length of the sequence input X, so there is a problem that the capacity of a required memory is exponentially increased so that the transformer performs an attention operation for a large amount of data.

The present disclosure is a method for solving this problem and may be composed of a row clustering process for reducing the dimension of a query vector Q (step S10 to step S40) and an attention value determination process using the dimension-reduced query vector Qc (step S50 to step S70).

Hereafter, first, the row clustering process (step S10 to step S40) is described in detail.

A processor can apply low rank approximation to a query vector Q or a key vector for input of the transformer (S10). As described with reference to FIG. 2, the query vector Q and the key vector K are used to calculate an attention score A_{S} and the processor can apply low rank approximation first to any one of the query vector Q and the key vector K to reduce resources required for calculation of the attention score A_{S}.

Referring to FIG. 3, in an example, the processor can reduce the magnitude of a key vector K by applying low rank approximation to the key vector K. In detail, the processor may apply low rank approximation through Singular Value Decomposition (SVD) for the key vector K or, if the key vector K is a square matrix, the processor may apply low rank approximation through Eigenvalue Decomposition (EVD). In addition, the processor can reduce the dimension of a vector by applying low rank approximation to a query vector Q or a key vector through various methodologies known in the art.

Next, the processor can calculate an approximate attention score by taking an inner product of the query vector Q and the key vector K (S20). In detail, as shown in FIG. 3, the processor can calculate an approximate attention score [symbol] = [symbol] by taking an inner product of any one vector, to which low rank approximation has been applied in step S10, among the query vector Q and the key vector K, and another vector Q.

Next, the processor can cluster a plurality of rows into at least one group on the basis of the similarity of a plurality of rows constituting the approximate attention score [symbol] .

Referring to FIG. 4 as an example, the approximate attention score [symbol] may be represented as an 8×8 matrix and the value of each element of the matrix may be represented by color (or shading). In this case, the processor can cluster the approximate attention score [symbol] on the basis of the similarity between the rows.

In an embodiment, the processor can cluster a plurality of rows into at least one group on the basis of the similarity between the elements constituting a plurality of rows. In detail, the processor can cluster a plurality of rows in which the similarity between elements is a reference value or more into one group. In this case, as the clustering technique, k-means clustering, hierarchical clustering, Density-based spatial clustering of applications (DBSCAN), etc. can be used, and the number of groups may be determined in accordance with the similarity between rows.

However, the operation resource may increase when it is required to calculate all of the similarities between elements, so in another embodiment, in consideration of this matter, the processor may cluster a plurality of rows into groups corresponding to the number of preset reference rows on the basis of the similarity between each of a plurality of rows and the reference rows.

In the example shown in FIG. 4, the processor can set three reference rows to cluster approximate attention score [symbol] into three groups. The processor calculates only the similarity between each row and the three reference rows rather than compare the similarity between all of the rows, thereby being able to cluster the rows constituting the approximate attention score [symbol] into a first group (group 1) with the highest similarity to the first reference row, a second group (group 2) with the highest similarity to the second reference row, and a third group (group 3) with the highest similarity to the third reference row.

Next, the processor can determine an index of the representative row of each of the clustered groups (S40). In other words, the processor can determine any one row that can represent each of the groups and an index for the row.

In an embodiment, the processor can determine the centroid of each of the clustered groups and can determine any one row closest to the centroid of the plurality of rows included in each of the groups as a representative row.

Referring to FIG. 5, in accordance with the operation of step S30, three rows having indexes #0, #3, and #7 can be clustered into a first group, three rows having indexes #1, #2, and #5 can be clustered into a second group, and two rows having indexes #4 and #6 can be clustered into a third group. In this case, the processor can determine the centroid of each of the groups, and when the clustering described above is performed by any one of means clustering, hierarchical clustering, and DBSCAN, the centroid of each of the clusters may have been determined already.

Unlike, when the centroid of each cluster is not determined, the processor can determine the centroid of each of the groups by averaging the elements constituting the plurality of rows in the groups in the row direction. In detail, in the example shown in FIG. 5, the processor can determine the centroid of the first group by averaging the elements of the three rows having indexes #0, #3, and #7 in the first group in the row direction. Further, the processor can determine the centroid of the second group by averaging the elements of the three rows having indexes #1, #2, and #5 in the second group in the row direction. Similarly, the processor can determine the centroid of the third group by averaging the elements of the two rows having indexes #4 and #6 in the third group in the row direction.

Unlike this, it is natural that the median of the rows in each group (in detail, the median of the elements) may be set as the centroid or the mode of the rows in each group (in detail, the mode of the elements) may be set as the centroid.

When the centroid of each group is determined, the processor can determine the index of any one row closest to the centroid from the plurality of rows included in each group.

Referring to FIG. 5 again, the processor can calculate the distance between each row and the centroid of the corresponding group and can specify the index of any one row with the shortest distance. For example, the processor can specify the row closest to the centroid of the first group as a row having the index #3, can specify the row closest to the centroid of the second group as a row having the index #5, and can specify the row closest to the centroid of the third group as a row having the index #4.

The index of the representative row of each group determined in this way is used to reduce the dimension of a query vector, and the process of determining an attention value using a dimension-reduced query vector Qc (step S50 to step S70) is described in detail hereafter.

The processor can create a sub-query vector Qc by extracting a row corresponding to an index determined in step S40 from a query vector Q (S50).

Since an approximate attention score [symbol] is calculated through an inner product of a query vector Q and a key vector K, the number of the rows of the approximate attention score [symbol] may be the same as the number of the rows of the query vector Q. The processor can create a sub-query vector Q_{C} by extracting only the row having an index determined in step S40 from a plurality of rows constituting a query vector Q.

Referring to FIG. 4 and FIG. 6, the number of the rows of a query vector Q may be the same as the number of the rows of an approximate attention score [symbol] as 8. As exemplified in FIG. 5, when the indexes of the representative rows of groups are determined as #3, #5, and #4, respectively, the processor can create a sub-query vector Q_{C} by extracting three rows having indexes 3, #5, and #4 from the rows constituting a query vector Q.

Next, the processor can calculate a sub-attention value A_{y}^{C} using the sub-query vector Q_{C} and the key vector (S60). In this case, the process of calculating the sub-attention value A_{y}^{C} may be the same as the method of calculating an attention value A_{V} described with reference to FIG. 2.

Describing with reference to FIG. 7, the processor can calculate a sub-attention score A_{S}^{C} by taking an inner product of the sub-query vector Q_{C} and the key vector K. Next, the processor can calculate a sub-attention value A_{V}^{C} by multiplying the sub-attention score A_{S}^{C} by a value vector V for input of the transformer. In this case, the processor can apply a normalization function and/or a softmax function to the sub-attention score A_{S}^{C}.

Next, the processor can determine an attention value [symbol] by copying the rows constituting the sub-attention value A_{V}^{C} to groups, respectively (S70). That is, since the sub-attention value A_{V}^{C} is calculated by a dimension-reduced query vector Q_{C}, the processor can determine an attention value [symbol] by expanding the dimension of the dimension-reduced query vector and simply copying can be used for the dimension expansion.

Referring to FIG. 8, the sub-attention value A_{V}^{C} calculated in step S60 may have three rows and the rows may correspond to the indexes of the representative rows determined in step S40, that is, the indexes #3, #5, and #4, respectively. The processor can determine an attention value [symbol] by copying the rows to the positions of the plurality of rows pertaining to the groups corresponding to the rows, respectively.

Describing in detail with reference to FIG. 4 and FIG. 8, the indexes 3, #5, and #4 may correspond to the first, second, and third groups, respectively. The processor can copy the row corresponding to the index #3 among the rows constituting the sub-attention value A_{V}^{V} to the positions of the plurality of rows pertaining to the first group, that is, #0, #3, and #7. Further, the processor can copy the row corresponding to the index #5 among the rows constituting the sub-attention value A_{V}^{C} to the positions of the plurality of rows pertaining to the second group, that is, #1, #2, and #5. Similarly, the processor can copy the row corresponding to the index #4 the among rows constituting the sub-attention value A_{V}^{C} to the positions of the plurality of rows pertaining to the third group, that is, #4 and #6.

As exemplified above, the processor can determine an attention value [symbol] having a magnitude of 8 by 8 through an operation only for three rows corresponding to the number of groups and can allow the transformer to perform tasks using the attention value [symbol] .

As described above, the present disclosure can greatly decrease calculation complexity and the capacity of a memory required for operations by reducing the data dimension of an attention operation through row clustering on the basis of the fact that most rows constituting an attention score of a transformer have similar patterns.

According to the present disclosure, since the clustering operation based on the similarity of a plurality of rows and the process of determining an attention value by copying values to the same group both can be performed in the unit of row, parallel operation of data of each data is possible, and accordingly, it is possible to apply a Single Instruction Multiple Data (SIMD) method based on a multi-core (multi-thread).

Referring to FIG. 9, when the SIMD method is applied to the present disclosure (SpARC), it can be seen that considerable operation speed improvement is shown in various datasets (SQUAD, MNLI, CLOTH, Wikitext, and ImageNet) in comparison to not only the edge computing method (EdgeCPU and EdgeGPU) of a CPU/GPU, but other existing attention operation methodologies (SpAtten and Sanger), and it can be seen that the energy efficiency is also the most excellent.

Although the present disclosure was described with reference to the exemplary drawings, it is apparent that the present disclosure is not limited to the embodiments and drawings in the specification and may be modified in various ways by those skilled in the art within the range of the spirit of the present disclosure. Further, even though the operation effects according to the configuration of the present disclosure were not clearly described with the above description of embodiments of the present disclosure, it is apparent that effects that can be expected from the configuration should be also admitted.

What is claimed is:

1. A method for determining an attention value of a transformer, the method comprising:
applying low rank approximation to a query vector or a key vector for input of a transformer by means of a processor;
calculating an approximate attention score by taking an inner product of the query vector and the key vector by means of the processor;
clustering a plurality of rows constituting the approximate attention score into at least one group on the basis of similarity of the plurality of rows by means of the processor;
determining an index of a representative row of each of the groups and creating a sub-query vector by extracting rows corresponding to indexes from the query vector by means of the processor;
calculating a sub-attention value using the sub-query vector and the key vector by means of the processor; and
determining an attention value by copying rows constituting the sub-attention value the groups, respectively, by means of the processor.

2. The method of claim 1, wherein the applying of low rank approximation includes applying the low rank approximation by applying Singular Value Decomposition (SVD) to the query vector or the key vector.

3. The method of claim 1, wherein the clustering includes clustering the plurality of rows into at least one group on the basis of similarity between elements constituting each of the plurality of rows.

4. The method of claim 1, wherein the clustering includes clustering the plurality of rows into groups corresponding to preset reference rows on the basis of similarity between each of the plurality of rows and the reference rows.

5. The method of claim 1, wherein the determining of an index of a representative row of each of the groups includes:
determining a centroid of each of the groups; and
determining any one row closest to the centroid among a plurality of rows included in each of the groups as the representative row.

6. The method of claim 5, wherein the determining of a centroid of each of the groups includes determining a centroid of each of the groups by averaging elements constituting a plurality of rows in the groups in a row direction.

7. The method of claim 1, wherein the calculating of a sub-attention value includes:
calculating a sub-attention score by taking an inner product of the sub-query vector and the key vector; and
calculating the sub-attention value by multiplying the sub-attention score by a value vector for input of the transformer.

8. The method of claim 1, wherein the determining of an attention value includes determining the attention value by copying rows constituting the sub-attention value respectively to positions of a plurality of rows pertaining to the groups corresponding to the rows, respectively.
